(19) United States
(12) Patent Application Publication
(10) Pub. No.: US 2014/0020140 A1
(43) Pub. Date: Jan. 16, 2014

(54) MULTI-HEAD PROBE AND MANUFACTURING AND SCANNING METHODS THEREOF

(71) Applicant: NATIONAL TSING HUA UNIVERSITY, Hsinchu (TW)

(72) Inventors: FAN-GANG TSENG, New Taipei City (TW); JOE-MING CHANG, Hsinchu City (TW)

(73) Assignee: NATIONAL TSING HUA UNIVERSITY, Hsinchu (TW)

(21) Appl. No.: 13/680,474

(22) Filed: Nov. 19, 2012

(30) Foreign Application Priority Data
Jul. 13, 2012 (TW) 101125367

(51) Int. Cl. G01Q 60/24; G01Q 60/38

(52) U.S. Cl. CPC G01Q 60/24; G01Q 60/38
USPC 850/33; 850/40

(57) ABSTRACT

A multi-head probe suitable for an atomic force microscopy (AFM) comprises a tip base, a single cantilever beam and at least two tips. The tip base has a tip end, which is ground to form a surface. The cantilever beam is connected to the tip base and for supporting the tip base. The at least two tips are disposed on the surface.

This application claims priority of No. 101125367 filed in Taiwan R.O.C. on Jul. 13, 2012 under 35 USC 119, the entire content of which is hereby incorporated by reference.

### BACKGROUND OF THE INVENTION

1. Field of the Invention

The invention relates to a multi-head probe, and more particularly to a multi-head probe with a single cantilever beam.

2. Related Art

A conventional atomic force microscope (hereinafter referred to as AFM) is restricted by the factors, such as the imaging principle and the machine structure (e.g., a scanner, a feedback circuit controller, a probe or the like), the conventional AFM has to spend several minutes of time to completely scan a high-resolution scan image. However, the action times of the transmission behavior of the biometrics live molecules, such as myosin, membrane protein or proton, on the membrane protein channel pertain to the millisecond level. So, when the conventional AFM is utilized to perform the scanning, the conventional AFM cannot acquire the molecule-levelhigh-resolution image within one millisecond of time.

### SUMMARY OF THE INVENTION

An object of the invention is to provide a multi-head probe and manufacturing and scanning methods thereof, which can increase the scan time resolution of the AFM.

Another object of the invention is to provide a multi-head probe and manufacturing and scanning methods thereof, which can acquire the rapid molecular dynamic image.

Still another object of the invention is to provide a multi-head probe and manufacturing and scanning methods thereof, which can obtain the dynamic and surface pattern of a single molecule at different timings in a single scan.

An embodiment of the invention provides a multi-head probe suitable for an atomic force microscopy (AFM). The multi-head probe includes a tip base, a single cantilever beam and at least two tips. The tip base has a tip end, which is ground to form a surface. The cantilever beam is connected to the tip base and supports the tip base. The at least two tips are disposed on the surface.

Another embodiment of the invention provides a method of manufacturing a multi-head probe, which is suitable for an atomic force microscopy (AFM). The method comprises: grinding a tip end of a tip base to form a surface; applying a bonding agent to the surface; and adhering a plurality of nanospheres to the surface through the bonding agent to form a plurality of tips.

Still another embodiment of the invention provides a method of scanning a multi-head probe, which is suitable for an atomic force microscopy (AFM). The method comprises: contacting a target by a first tip at a first time t₁; and contacting the target by a second tip at a second time t₂. The first tip and the second tip are disposed on a surface, a predetermined gap L is formed between the first tip and the second tip, the multi-head probe operates at a speed V, and a time interval between scanning of the target by the first tip and the second tip is represented by ΔT=t₂−t₁=L/V.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a multi-head probe according to an embodiment of the invention.

FIG. 2 shows a photograph of the multi-head probe of the invention.

FIG. 3A is a schematic illustration showing that the multi-head probe of the invention performs scanning at the time t₁ as well as the target morphology.

FIG. 3B is a schematic illustration showing that the multi-head probe of the invention performs scanning at the time t₂ as well as the target morphology.

FIG. 4 is a flow chart showing a method of manufacturing a multi-head probe according to an embodiment of the invention.

FIGS. 5A to 5D are decomposed schematic illustrations showing the manufacturing method.

### DETAILED DESCRIPTION OF THE INVENTION

The present invention will be apparent from the following detailed description, which proceeds with reference to the accompanying drawings, wherein the same references relate to the same elements.

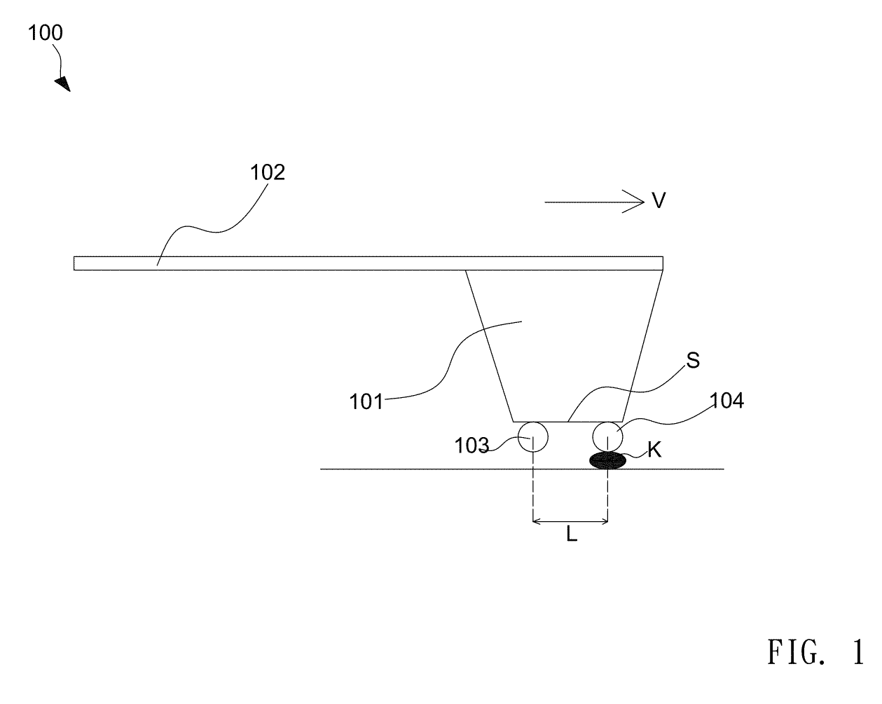

FIG. 1 is a schematic illustration showing a multi-head probe 100 according to an embodiment of the invention. Referring to FIG. 1, the multi-head probe 100 includes a tip base 101, a cantilever beam 102, a tip 103 and a tip 104. When the multi-head probe 100 is operating, the tips 103 and 104 contact a target K within a time interval ΔT.

In one embodiment, the multi-head probe 100 is suitable for an atomic force microscopy (hereinafter referred to as AFM), and the target K may be implemented by biometrics live molecules, such as myosin, membrane protein or the like. However, the target K should not be restricted to be implemented by the biometrics live molecules, and may also be implemented by non-biometrics live molecules.

It is to be noted that the tip base 101 in one embodiment may be implemented using the existing single-head probe. So, the tip base 101 has a tip end (not shown), which is ground to form a surface S.

In another embodiment, the AFM applies a scanning force to the tip base 101 to make the tip base 101 form the surface S. For example, the AFM scans a wafer, on which the silicon nitride is deposited, at a constant speed, wherein the area size of the surface S can be determined according to the grinding length of the grinding process on the tip. In addition, the tip base 101 before grinding may be implemented by a single-head probe.

The multi-head probe 100 of the invention may be manufactured by recycling the existing single-head probe, and grinding the tip end of the single-head probe to form a level surface S. So, the cost can be saved.

In addition, the multi-head probe 100 of the invention uses a single cantilever beam 102, which is connected to a lateral side of the tip base 101 and has one end for supporting the tip base 101 and the other end attached to the AFM.

It is to be noted that the tips 103 and 104 of the multi-head probe 100 are disposed on the surface S, and the invention does not intend to restrict the number of tips, so that the number of tips 103 or 104 on the surface S may be increased according to the user's requirements. In this embodiment, the tips 103 and 104 may be implemented by a plurality of nanospheres (e.g., polystyrene nanospheres), wherein a bonding agent (e.g., AB epoxy resin or UV adhesive) may be used to adhere and fix the nanospheres to the surface S.

In one embodiment, when the resin bonding agent is applied to the surface S and a layer of nanospheres is contacted to the surface S, the nanospheres can be adhered to the surface S, wherein the number of nanospheres may be controlled by the radii of the nanospheres and the area of the surface S. In another embodiment, the material of the nanosphere may be Teflon.

In this embodiment, if a predetermined gap L is formed between the tips 103 and 104, and the multi-head probe 100 operates at a speed V, then the time interval when the multi-head probe 100 is operating is represented by A T=L/V. In other words, the interval time between scanning by the tips 103 and 104 is the time interval ΔT.

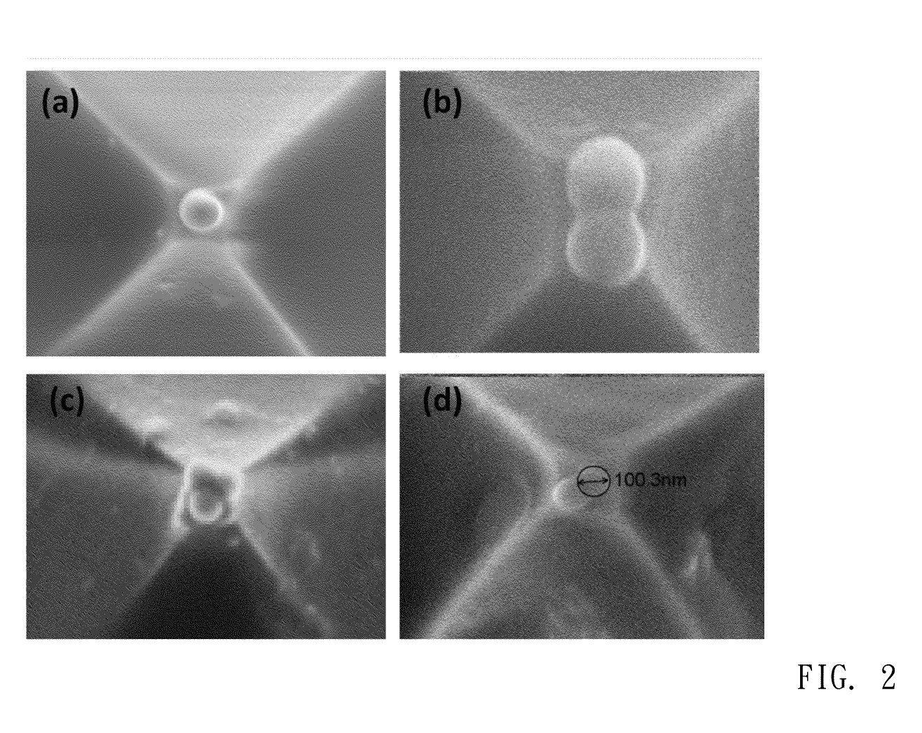

In addition, the width of the surface S is directly proportional to the radii of the nanospheres (tips 103 and 104). FIG. 2 shows a photograph of the multi-head probe of the invention. Please refer also to FIG. 2, wherein (a) represents that one single nanosphere is placed on the surface S; (b) represents that two nanospheres with the diameter of 250 nm are placed on the surface S; (c) represents that three nanospheres with the diameter of 250 nm are placed on the surface S; and (d) represents that two nanospheres with the diameter of 100 nm are placed on the surface S. According to (a), (b), (c) and (d), it is understood that the number of the nanospheres is not particularly restricted, and the number(s) of the tip(s) 103 or 104 on the multi-head probe 100 may be adjusted according to the radii of the nanospheres and the area of the surface S.

Furthermore, the predetermined gap L of the multi-head probe 100 may be controlled artificially, and the time interval ΔT of scanning the target K by the multi-head probe 100 can be adjusted according to the predetermined gap L.

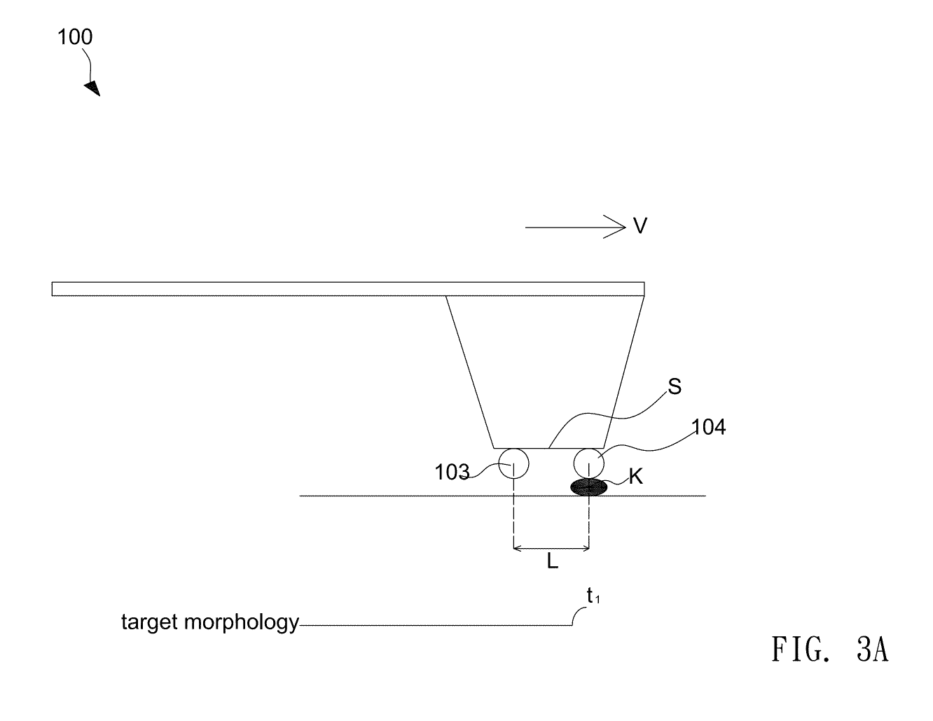

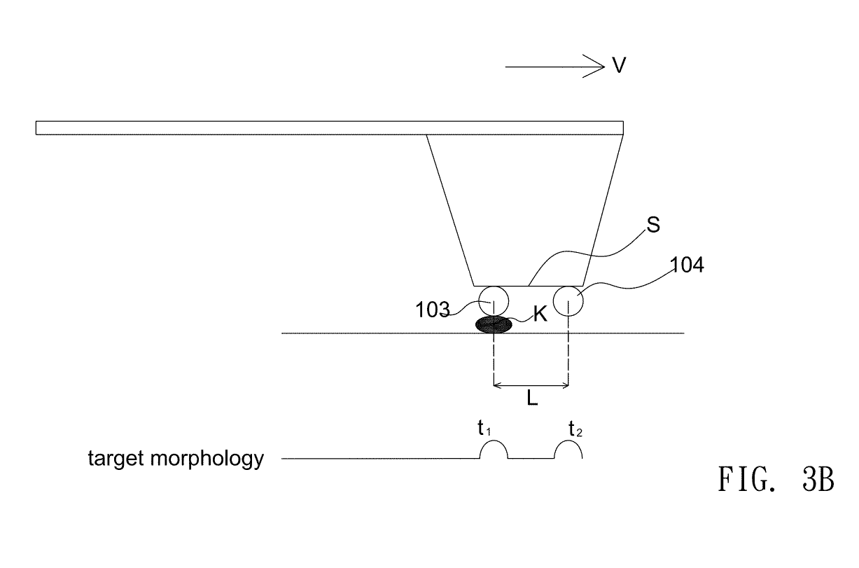

Please refer to FIGS. 3A and 3B. FIG. 3A is a schematic illustration showing that the multi-head probe of the invention performs scanning at the time t₁ as well as the target morphology. FIG. 3B is a schematic illustration showing that the multi-head probe of the invention performs scanning at the time t₂ as well as the target morphology. If the tips 103 and 104 are disposed on the same surface S, the tip 103 contacts the target K at the time t₁, the tip 104 contacts the target K at the time t₂, a predetermined gap L is formed between the tips 103 and 104 and the multi-head probe 100 of the AFM operates at the speed V, then the time interval between scanning the target K by the tips 103 and 104 is represented by A T=t₂−t₁=L/V.

In one embodiment, the distance between the top ends of the tips 103 and 104 is 250 nm, and the scanning speed of the AFM is 10 μm/s. So, we can recognizable and observe the dynamic or stationary variation of scanning the target K within 0.025 seconds. In another embodiment, if the probe having the distance between the top ends of the tips 103 and 104 is smaller than or equal to 10 nm, the target K can be completely scanned within a millisecond.

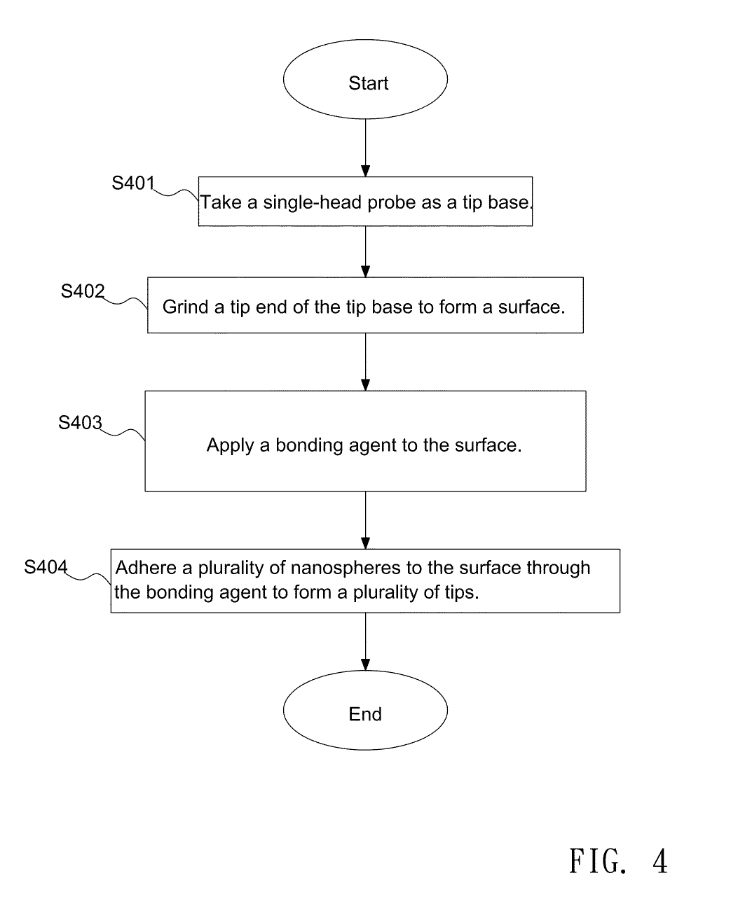

FIG. 4 is a flow chart showing a method of manufacturing a multi-head probe according to an embodiment of the invention. Referring to FIG. 4, the method includes the following steps.

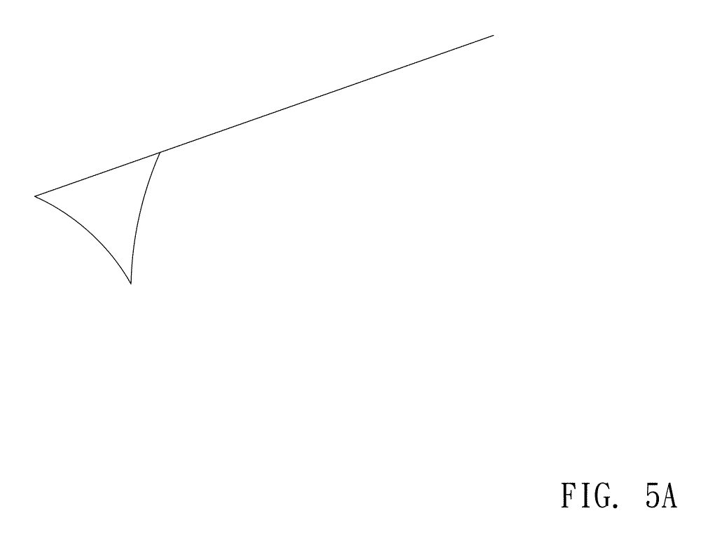

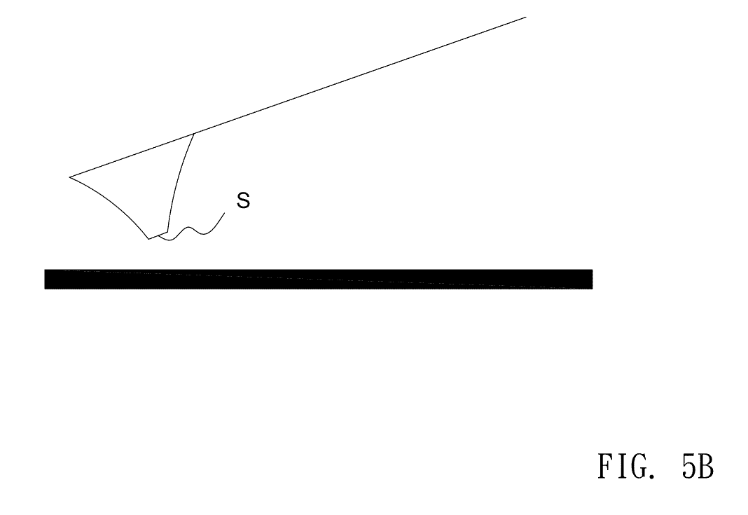

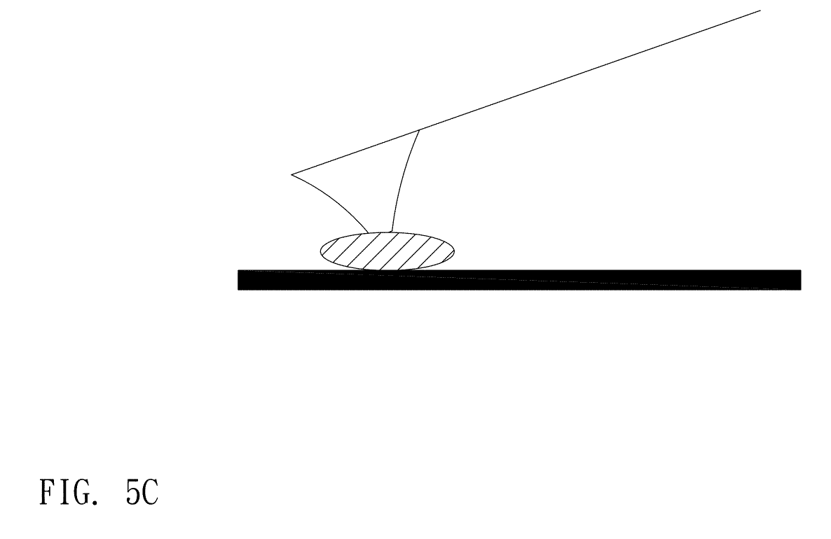

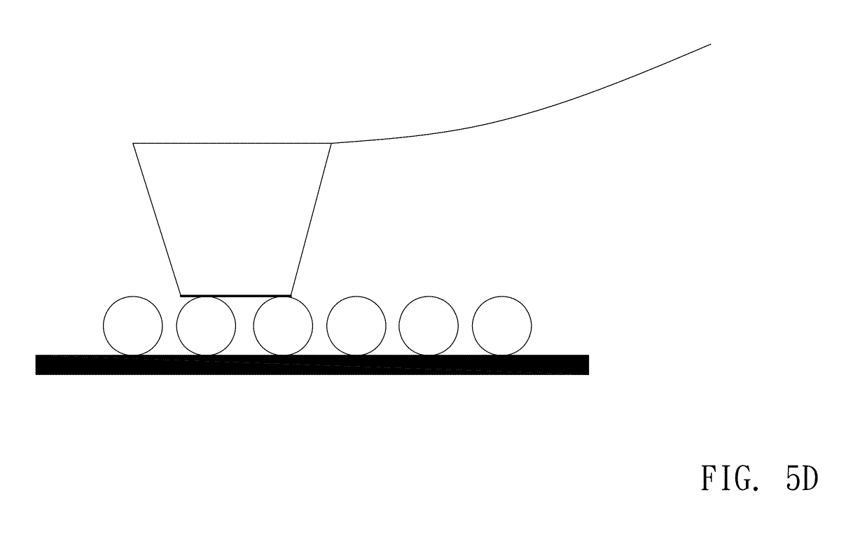

In step S401, a single-head probe is taken as the tip base. Please also refer to FIG. 5A showing the decomposed schematic illustration of the manufacturing method.

In step S402, the tip end of the tip base is ground to form a surface S. Please also refer to FIG. 5B showing the decomposed schematic illustration of the manufacturing method.

In step S403, a bonding agent is applied to the surface. Please also refer to FIG. 5C showing the decomposed schematic illustration of the manufacturing method, wherein the hatched portion represents the bonding agent.

In step S404, a plurality of nanospheres is adhered to the surface through the bonding agent to form a plurality of tips. Please also refer to FIG. 5D showing the decomposed schematic illustration of the manufacturing method.

In summary, the multi-head probe of the invention improves the restrictions of the gap of the original AFM probe and the scan time resolution. In addition, the manufacturing method of the multi-head probe of the invention has the advantages of the easy and rapid preparation, and more than two tips can be concentrated within the range of the nano-scale distance without modifying the AFM machine. So, the multi-head probe can continuously analyze the dynamic or stationary variation of the object or biometrics body at the time interval within one millisecond.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A multi-head probe suitable for an atomic force microscopy (AFM), the multi-head probe comprising:
a tip base having a tip end, which is ground to form a surface;
a single cantilever beam, which is connected to the tip base and supports the tip base; and
at least two tips disposed on the surface.

2. The multi-head probe according to claim 1, wherein the tips are adhered to the surface by a plurality of nanospheres and through a bonding agent.

3. The multi-head probe according to claim 2, wherein an area size of the surface is determined according to the grinding length of the grinding process on the tip.

4. The multi-head probe according to claim 3, wherein a width of the surface is directly proportional to radii of the nanospheres.

5. The multi-head probe according to claim 4, wherein when the multi-head probe is operating, the tips contact a target within a time interval.

6. The multi-head probe according to claim 5, wherein a predetermined gap L is formed between the tips, the multi-head probe operates at a speed V, and the time interval is represented by ΔT=L/V.

7. A method of manufacturing a multi-head probe, which is suitable for an atomic force microscopy (AFM), the method comprising:
grinding a tip end of a tip base to form a surface;
applying a bonding agent to the surface; and
adhering a plurality of nanospheres to the surface through the bonding agent to form a plurality of tips.

8. The method according to claim 7, wherein an area size of the surface is determined according to a time of grinding the tip end.

9. The method according to claim 7, wherein a width of the surface is directly proportional to radii of the nanospheres.

10. A method of scanning a multi-head probe, which is suitable for an atomic force microscopy (AFM), the method comprising:
contacting a target by a first tip at a first time t₁; and
contacting the target by a second tip at a second time t₂,
wherein the first tip and the second tip are disposed on a surface, a predetermined gap L is formed between the first tip and the second tip, the multi-head probe operates at a speed V, and a time interval between scanning of the target by the first tip and the second tip is represented by A T=t₂−t₁=L/V.
